(19) United States
(12) Patent Application Publication
(10) Pub. No.: US 2010/0138742 A1
(43) Pub. Date: Jun. 3, 2010

(54) Method and Apparatus for Displaying Information Related to User Actions

(75) Inventors: Jukka Antero Holm, Tampere (FI); Antti Johannes Eronen, Tampere (FI); Arto Juhani Lehtiniemi, Lempaala (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/326,673

(22) Filed: Dec. 2, 2008

(51) Int. Cl. G06F 3/00

(52) U.S. Cl. 715/700

(57) ABSTRACT

In accordance with an example embodiment of the present invention, an apparatus comprising a processor configured to transmit data based at least in part on an action of users related to consumed media. Further the apparatus comprises a user interface configured to display an indicator associated with the data.

### RELATED APPLICATIONS

This application relates to U.S. Patent Application, titled “METHOD AND APPARATUS FOR GENERATING AN INFORMATION LIST ASSOCIATED WITH A USER”, which is being filed concurrently and is hereby incorporated by reference in its entirety.

### TECHNICAL FIELD

The present application relates generally to displaying information for user actions.

### BACKGROUND

Electronic devices are used for many different applications. As such, applications for electronic devices are increasing in number. In some cases, these electronic devices may include location information. As such, electronic devices may identify the location of the electronic device.

### SUMMARY

Various aspects of examples of the invention are set out in the claims.

According to a first aspect of the present invention, an apparatus comprising a processor configured to transmit data based at least in part on an action of users related to consumed media. Further the apparatus comprises a user interface configured to display an indicator associated with the data.

According to a second aspect of the present invention, a method comprising obtaining data based at least in part on an action of users related to consumed media and displaying an indicator associated with the data.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram of an electronic device and a server operating in accordance with an example embodiment of the invention;

FIG. 3A is a flow diagram depicting an example method for displaying an information list in accordance with an example embodiment of the invention;

FIG. 3B is a flow diagram depicting an example method for transmitting an information list in accordance with an example embodiment of the invention;

FIG. 4 is a screen view depicting a user interface operating in accordance with an example embodiment of the invention;

FIG. 5 is a block diagram of an electronic device and a server operating in accordance with an example embodiment of the invention;

FIG. 6A is a flow diagram depicting an example method for displaying data in accordance with an example embodiment of the invention;

FIG. 6B is a flow diagram depicting an example method for providing access to data in accordance with an example embodiment of the invention;

FIG. 7A is a screen view depicting a user interface sharing an ownership view in accordance with an example embodiment of the invention;

FIG. 7B is a screen view depicting a user interface sharing another ownership view in accordance with an example embodiment of the invention;

FIG. 7C is a screen view depicting a user interface sharing a movement view movement view in accordance with an example embodiment of the invention;

FIG. 7D is a screen view depicting a user interface sharing an icon view in accordance with an example embodiment of the invention; and

FIG. 7E is a screen view depicting a user interface sharing a text view in accordance with an example embodiment of the invention.

### DETAILED DESCRIPTION OF THE DRAWINGS

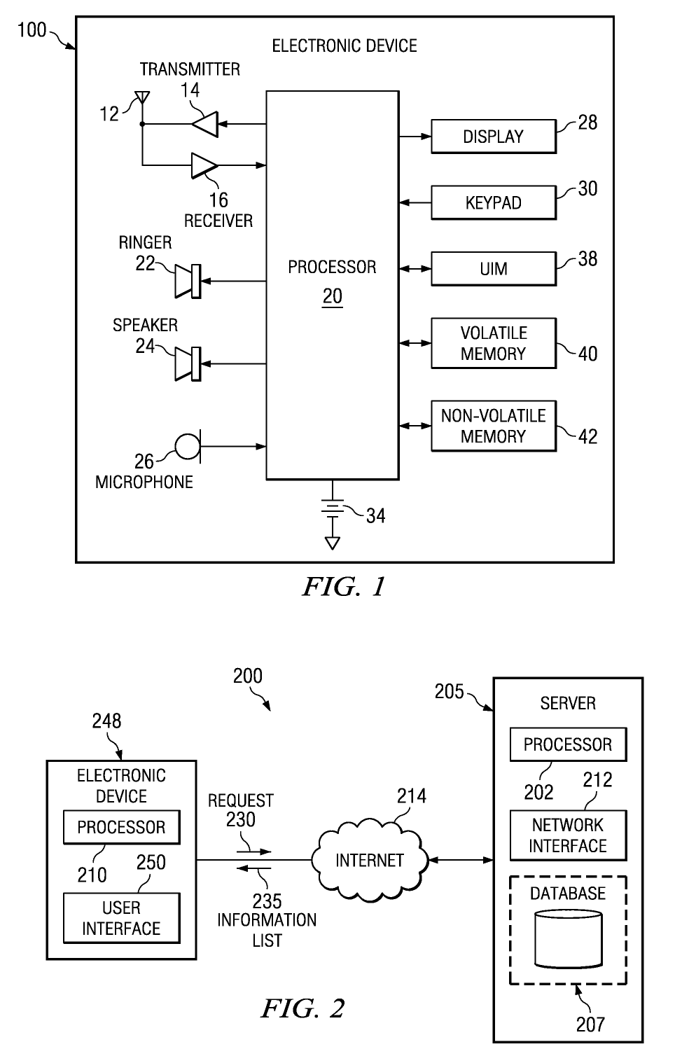

An example embodiment of the present invention and its potential advantages are best understood by referring to FIGS. 1 through 7E of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 comprises a user interface comprising one or more input or output devices, such as a conventional earphone or speaker 24, a ringer 22, a microphone 26, a display 28, and/or the like. In an embodiment, the one or more output devices of the user interface are coupled to the processor 20.

In an example embodiment, the user interface allows the electronic device 100 to receive or transmit data. For example, the user interface may comprise any of a number of devices configured to receive data, such as a keypad 30, a touch display, other input device, and/or the like. In an embodiment, the keypad 30 comprises the conventional numeric, e.g., 0-9, and/or related keys, e.g., #, *, other hard and/or soft keys, and/or the like to operate the electronic device 100. In an alternative embodiment, the keypad 30 comprises a conventional QWERTY keypad arrangement. Further, the keypad 30 may also comprise various soft keys with associated features. If desired, the electronic device 100 may comprise a user interface device, such as a joystick or the like.

In an embodiment, the electronic device 100 comprises a battery 34, such as a vibrating battery pack, for powering various circuits to operate the electronic device 100. Further, the vibrating battery pack may also provide mechanical vibration as a detectable output. In an embodiment, the electronic device 100 further comprises a user identity module (UIM) 38. In an example embodiment, the UIM 38 is a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 comprises memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 comprises memory. For example, the processor 20 may comprise volatile memory 40, non-volatile memory 42, and/or the like.

In an embodiment, the electronic device 100 uses memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 comprises circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 are allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 is capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 is capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 is capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 is capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

FIG. 2 is a block diagram of an electronic device 248 and a server 205 operating in accordance with an example embodiment of the invention. In an example embodiment, the server 205 comprises a network interface 212, a processor 202, and optionally a database 207.

In an example embodiment, the server 205 and/or the processor 202 comprises memory. For example, the server 205 comprises volatile memory, such as random access memory (RAM). RAM may comprise a cache area for the temporary storage of data. Further, the server 205 may also comprise non-volatile memory, such as read only memory (ROM), which may be embedded and/or may be removable. The non-volatile memory may also comprise an electrically erasable programmable read only memory (EEPROM), flash memory, and/or the like. In an embodiment, the processor 202 communicates with internal and/or external components through the input/output circuitry. Further, the processor 202 may carry out a variety of techniques, as dictated by software instructions, firmware instructions, and/or the like.

In an example embodiment, the electronic device 248 comprises a user interface 250 and/or a processor 210, and/or the like. In an example embodiment, the electronic device 248 is similar to electronic device 100 of FIG. 1 and the processor 210 is similar to the processor 20 of FIG. 1. In an alternative embodiment, the electronic device 248 is different than electronic device 100 of FIG. 1 and the processor 210 is different than the processor 20 of FIG. 1.

The electronic device 248 may be in communication with the server 205, via a network, such as Internet 214. For example, the electronic device 248 may issue a request 230 associated with a group. In an example embodiment, a group is at least one of the following: a resident of a location, a non-resident of the location, a member of an affiliation, one or more users, a combination thereof, and/or the like. For example, a group may be a resident and/or a non resident of a city, a member of a club, such as a fan club, and/or the like. In an embodiment, the location is at least one of the following: longitude coordinate, latitude coordinate, a combination thereof, and/or the like.

In an example embodiment, the request 230 comprises a group associated with the request 230, a category, and/or the like. For example, the request 230 comprises a group of Paris residents associated with a category, such as top ten songs.

In an example embodiment, the processor 210 of the electronic device 248 is configured to send a request 230 associated with a group. For example, the processor 210 sends the request 230 to the server 205. The request 230, for example, may comprise a group of Paris residents and a category of top ten songs associated for the Paris residents.

In an example embodiment, the network interface 212 of the server 205 is configured to receive the request 230 from the electronic device 248. In an embodiment, the processor 202 is configured to generate an information list 235 based at least in part on the group. In an embodiment, the information list 235 comprises at least one of the following: a user identification, a media identification, a combination thereof, and/or the like.

In an example embodiment, the server 205 is configured to monitor a user's media use. For example, the server 205 monitors listening to music. In an embodiment, the server 205 stores the monitored information. For example, each the user uses media, the server 205 receives information identifying the media, e.g., artist, track name, album, location coordinates, and/or the like. In an embodiment, the location coordinates are global positioning system coordinates or a cellular identification.

In an embodiment, the user identification relates to one or more users associated with the group. For example, the user identification may relate to Paris residents. Further, the media identification may relate to one or more media, such as audio, video, a combination thereof, and/or the like. For example, the media identification may relate to top ten songs. In an embodiment, the information list 235 comprises the top ten songs for Paris residents.

In an alternative embodiment, the user identification relates to one or more users associated with the group, such as a community group. For example, the user identification may relate to a community group, such as a music fan club. Further, the media identification may relate to one or more media, such as audio, video, a combination thereof, and/or the like. For example, the media identification may relate to song for an artist of the fan club. In an embodiment, the information list 235 comprises the top song plays for the fan group. It should be understood that any number of variations of groups, user identification, and/or media identification may be employed by example embodiments of the invention.

In an example embodiment, the processor 202 generates the information list 235 by using a structured query language (SQL). In an example embodiment, SQL is a standard interactive and/or programming language for querying and modifying data and managing databases, such as database 207, using queries. A query allows retrieval of data based at least in part on criteria. For example, the processor 202 may issue a query to database 207 requesting information based on the group, e.g., residents of Paris, and/or the category, e.g., top ten songs. The query provides the processor 202 the information list 235 comprising the matching results of the query.

In an embodiment, the processor 202 is configured to store the information list 235 in the database 207 to access in a subsequent request, such as request 230. In such a case, the processor 202 may perform a look-up or otherwise accesses data in the database 207 to obtain the information list 235 for the request 230. A possible technical effect of one or more of the example embodiments disclosed herein is storing an information list associated with a group. In an embodiment, the processor 202 is also configured to transmit the information list 235 over the Internet 214 to the electronic device 248.

In an example embodiment, the processor 210 of the electronic device 248 is configured to receive the information list 235 from, for example, the server 205. In an example embodiment, the user interface 250 of the electronic device 248 is configured to display the information list 235. For example, the user interface 250 displays the information list 235 comprising the top ten played songs for Paris residents. In an embodiment, the user interface 250 displays the information list 235 with a map indicating geographic location.

In an embodiment, users of the map and/or information list 235 participate in an interactive game. For example, users of the map and/or information list 235 may attempt to overtake a geographic area by increasing the number of music plays for an artist and as such moving the artist to the “top ten.” In such a case, the user interface 250 may display an information list 235 and the map representing the increasing number of music plays for the artist. It should be understood that any number of the information lists, such as information list 235, may be generated and/or displayed. A possible technical effect of one or more of the example embodiments is displaying an information list associated with a group.

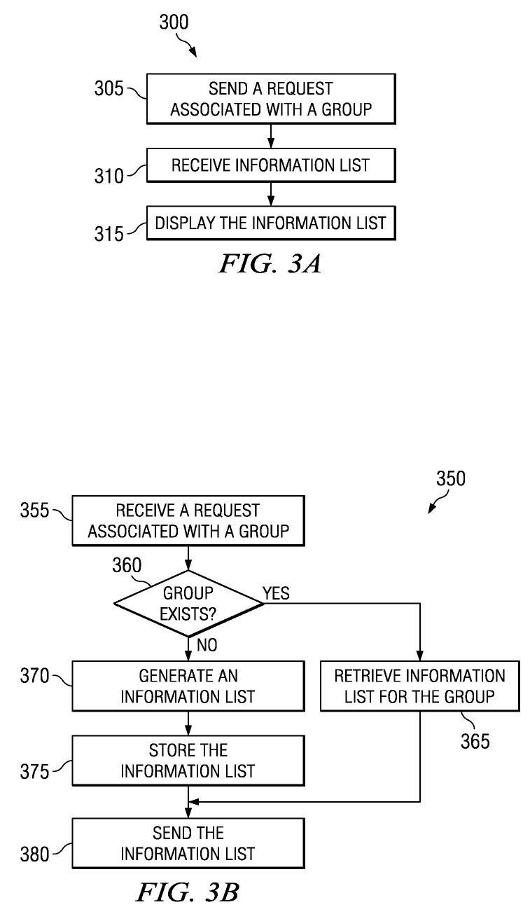

FIG. 3A is a flow diagram depicting an example method 300 for displaying an information list in accordance with an example embodiment of the invention. Example method 300 may be performed by an electronic device, such as electronic device 248 of FIG. 2.

At 305, a request, such as request 230 of FIG. 2, associated with a group is sent. In an embodiment, a group is at least one of the following: a resident of a location, a non-resident of the location, a member of an affiliation, a combination thereof, and/or the like. For example, a group may be residents and/or non residents of a city, a member of a club, and/or the like. In an example embodiment, the request comprises a group associated with the request, a category, and/or the like. For example, the request may comprise a group of Paris residents associated with a category, such as top ten songs. In an example embodiment, the electronic device sends a request to a server, such as server 205 of FIG. 2.

At 310, an information list, such as information list 235 of FIG. 2, for the group is received. In an embodiment, the information list comprises at least one of the following: a user identification, a media identification, or a combination thereof. In an embodiment, the user identification relates to one or more users associated with the group and/or the like. For example, the information list may comprise top ten songs for Paris residents where the group is Paris residents. In an embodiment, the media identification relates to at least one of the following: audio, video, a combination thereof, and/or the like. In an example embodiment, the electronic device receives an information list from the server.

At 315, the information list is displayed. In an example embodiment, a user interface, such as user interface 250 of FIG. 2, displays the information list. For example, the user interface displays an information list comprising top ten played songs for Paris residents.

FIG. 3B is a flow diagram depicting an example method 350 for transmitting an information list in accordance with an example embodiment of the invention. Example method 350 may be performed by a server, such as server 205 of FIG. 2.

At 355 a request, such as request 230 of FIG. 2, associated with a group is received. In an example embodiment, a network interface, such as network interface 212 of FIG. 2, of the server is configured to receive the request. For example, the server receives the request from the electronic device.

At 360 it is determined whether a group exists. If at 360 it is determined that the group exists, then at 365 an information list for the group is retrieved. In an example embodiment, the server performs a look-up or otherwise accesses data in a database, such as database 207 of FIG. 2, to obtain the information list. The example method 355 continues at 380.

If at 360 it is determined that the group does not exist, then at 370 an information list is generated. In an example embodiment, the server generates an information list by using a structured query language (SQL). For example, the server may issue a query to the database requesting the information list based at least in part on the group, e.g., residents of Paris, and/or the category, e.g., top ten songs. For example, the information list comprises the matching results for top ten songs of Paris residents.

At 375, the information list is stored. In an example embodiment, the server stores the information list generated at 370 based at least in part on the group in a database and/or the like.

At 380, the information list is sent. In an example embodiment, the server sends the information list to an electronic device, such as electronic device 248 of FIGURE.

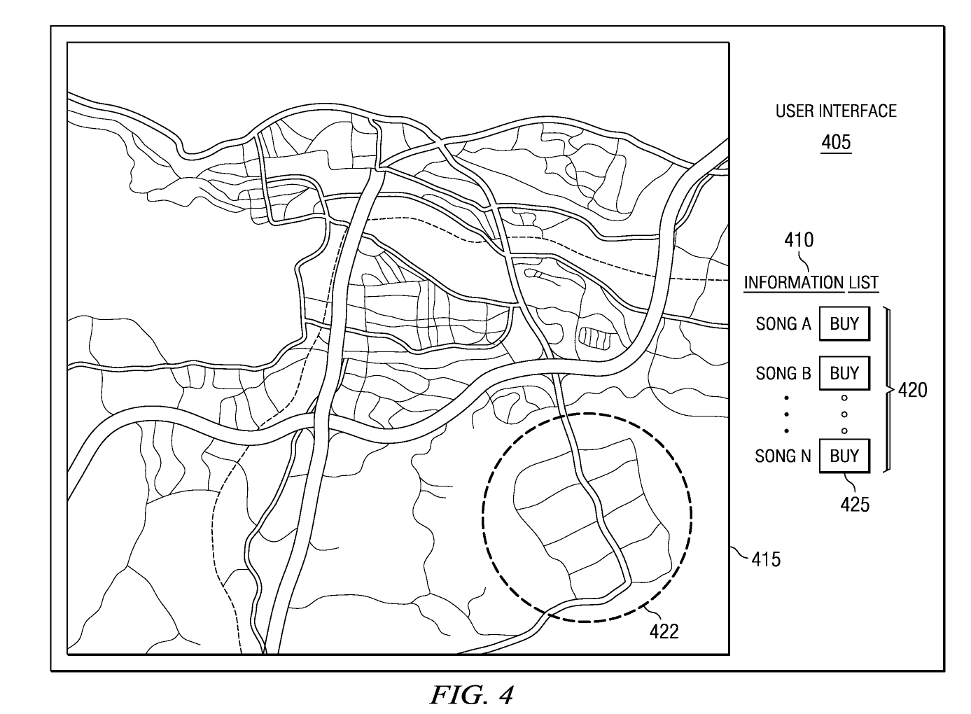

FIG. 4 is a screen view depicting a user interface 405 operating in accordance with an example embodiment of the invention. In an embodiment, an electronic device, such as electronic device 248, comprises a user interface, such as user interface 405. In an example embodiment, the user interface 405 is configured to display a map 415 and/or an information list 410. In an embodiment, the map 415 represents a location 422 for a group, such as Hervanta residents.

In an example embodiment, the information list 410 is a listing of media identification, such as songs A-N 420. The information list 410 may be associated with the group location 422. For example, songs A-N 420 are the top ten songs for the Hervanta location. Other displays of the group location 422 and information list 410 are also possible. In an example embodiment, the user interface 405 allows a user to highlight an area, such as a suburb, on the map 415. In such a case, information about the highlighted area is sent to a server, such as server 205 of FIG. 2. In an embodiment, the server sends an information list, such as information list 410, associated with the highlighted area. In an alternative embodiment, the user interface 405 allows a user to select a location from a list, top songs from a location, and/or the like. In such a case, the server determines determined the information list 410 based at least in part based on Global Positioning System (GPS) data. For example, the server provides an information list using the user's current location to determine what media is associated with the location.

In an embodiment, the user interface 405 displays a buy button 425. In an example embodiment, the user interface 405 is configured to allow a user to buy a media, such as song A-N 420. For example, a user of an electronic device, such as electronic device 248 of FIG. 2, may press or otherwise activate the buy button 425. In an embodiment, a processor, such as processor 210 of FIG. 2, of the electronic device sends a purchase request to a server, such as server 205 of FIG. 2, for the media, e.g., song A-N 420. Techniques known in the art may be employed to complete the transaction.

In an embodiment, the user interface 405 is similar to user interface 250 of FIG. 2 and the information list 410 is similar to information list 235 of FIG. 2. In an alternative embodiment, the user interface 405 and/or the information list 410 are different than the user interface 250 of FIG. 2 and/or information list 235 of FIG. 2 respectively.

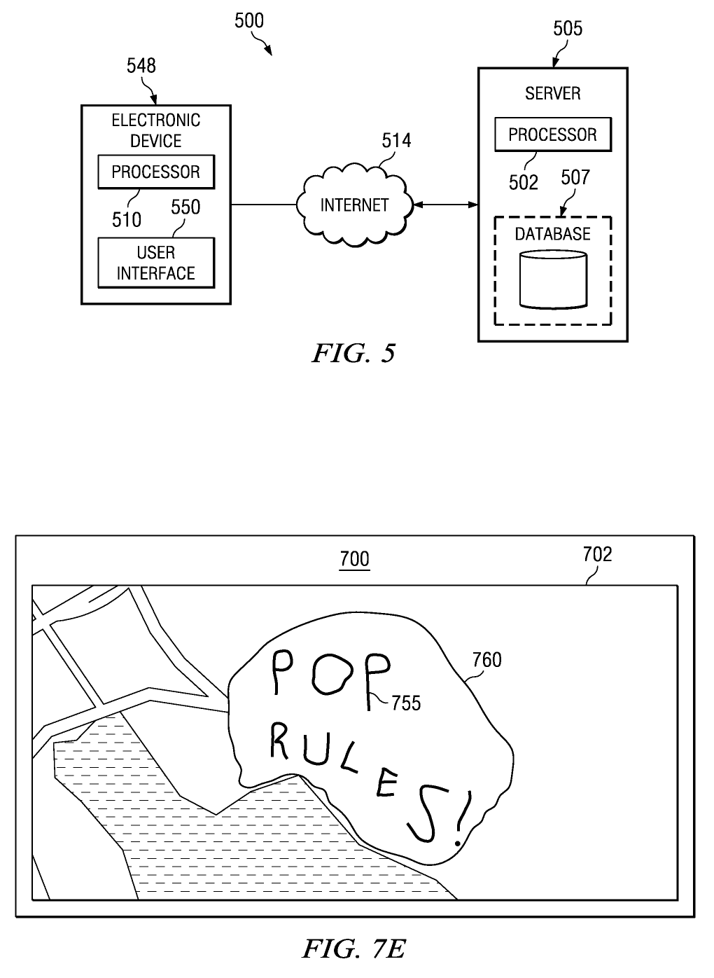

FIG. 5 is a block diagram of an electronic device 548 and a server 505 operating in accordance with an example embodiment of the invention. In an example embodiment, the server 505 comprises a processor 510 and optionally a database 507. In an embodiment, a database is a collection of data organized for convenient access.

In an embodiment, the server 505 and/or the processor 502 comprises memory. For example, the server 505 may comprise volatile memory, such as random access memory (RAM). RAM may comprise a cache area for the temporary storage of data. Further, the server 505 may also comprise non-volatile memory, such as read only memory (ROM), which may be embedded and/or may be removable. The non-volatile memory may also comprise an electrically erasable programmable read only memory (EEPROM), flash memory, and/or the like. In an embodiment, the processor 502 communicates with internal and/or external components through the input/output circuitry. Further, the processor 502 may carry out a variety of techniques, as dictated by software instructions, firmware instructions, and/or the like.

In an example embodiment, the electronic device 548 comprises a user interface 550 and/or a processor 510, and/or the like. In an example embodiment, the electronic device 548 is similar to electronic device 100 of FIG. 1 and the processor 510 is similar to the processor 20 of FIG. 1. In an alternative embodiment, the electronic device 548 is different than electronic device 100 of FIG. 1 and the processor 510 is different than the processor 20 of FIG. 1. In an example embodiment, the electronic device 548 is similar to electronic device 248 of FIG. 2 and the processor 510 is similar to the processor 210 of FIG. 2. In an alternative embodiment, the electronic device 548 is different than electronic device 248 of FIG. 2 and the processor 510 is different than the processor 210 of FIG. 2.

In an embodiment, the processor 510 of electronic device 548 is configured to connect to a server, a service, another electronic device, and/or the like. In an example embodiment, the server 505 is configured to establish a connection with electronic device 548. For example, the server 505 establishes a connection over the internet 514 with electronic device 548.

In an example embodiment, the processor 510 of electronic device 548 is configured to obtain data based at least in part on an action of users related to consumed media. In an example embodiment, a user is at least one of the following: a resident of a location, a non-resident of the location, a member of an affiliation, a group of members, a combination thereof, and/or the like. In an embodiment, the action relates to using media, changing a geographic location, making a phone call, watching an advertisement, using an application, sending a message, and/or the like. In an example embodiment, the data relates to at least one user of the users, e.g., a user using media, changing a geographic location, and/or the like. In an example embodiment, the consumed media is at least one of the following: an audio file, a video, a text file, a podcast, an image sharing application, a really simple syndication reader, a rich summary site reader, a resource description framework summary site reader, and/or the like. For example, the processor 510 obtains data relating to at least one user listening to a genre of music, e.g., pop music.

In an example embodiment, the processor 502 of the server 505 is configured to receive data associated with consumed media of users. For example, the processor 502 receives data associated with a user's media genre preference, such as pop music. In an embodiment, the processor 510 of the electronic device 548 transmits a user identification and password for authentication on the server 505. For example, the processor 502 transmits a member identification and password to authenticate the user on the server 505.

In an example embodiment, the processor 502 of the server 505 is configured to update data based at least in part on the consumed media. In an example embodiment, the data is stored in the database 507. For example, the data may be updated with the consumed media, e.g., pop music song, using a structured query language of the database 507. In an example embodiment, structured query language is a standard interactive and/or programming language for querying and modifying data and managing databases, such as database 507, using queries. A possible technical effect of one or more of the example embodiments disclosed herein is updating the data based at least in part on the consumed media.

In an example embodiment, the processor 502 of the server 505 is configured to provide access to data for each of the users. For example, the processor 502 allows access to the data via the database 507. In an example embodiment, the processor 510 of electronic device 548 is configured to obtain data for each of the users comprising in part the data. For example, the processor 510 issues a structured query language query to the server 505 to obtain the data associated with the users. In an embodiment, the user interface 550 is configured to display the data. For example, the user interface 550 displays music relating to genre preferences for each of the group of members.

In an example embodiment, the user interface 550 is configured to display the data on a map. Further, the user interface 550 may display the data in at least one of the following views: a movement view, an ownership view, an icon view, or a text view.

In an example embodiment, the user interface 550 displays an indicator associated with the data. In an example embodiment, the indicator is at least one of the following: a color, graphical icon, text, or a combination thereof associated with at least one of the users. For example, the user interface 550 displays a map with an indicator, such as an icon, which represents at least one user of the users. In an embodiment, the user interface 550 displays movement for at least one of the users. For example, the user interface 550 displays a running path and/or speed for a user of the electronic device 548.

In an embodiment, users of the electronic device 548 may participate in an interactive game. For example, the users overtake a geographic area by increasing the number of music plays for an artist or genre. In such a case, the user interface 250 may display a representation of ownership, such as coloring or otherwise marking a map, for the users in the geographic area. A possible technical effect of one or more of the example embodiments is displaying a representation of ownership for the users in a geographic area.

In an example embodiment, the processor 502 of the server 505 may be configured to send a media recommendation to a user not associated with the users based at least in part on the data. For example, the processor 502 sends a pop music recommendation to a user in the geographic location owned by the group of members. In an alternative embodiment, the processor 502 of the server 505 may be configured to send a media recommendation to a user associated not associated with the consumed media. In an example embodiment, the server 505 obtains the media recommendation from the database 507.

In an example embodiment, the processor 510 of the electronic device 548 is configured to receive a media recommendation for a user associated with the users based at least in part on the consumed media. For example, a user of the electronic device 548 receives a recommendation to listen to a pop song from the server 505 based on the users listening to pop music. In an alternative embodiment, another electronic device is configured to receive a media recommendation to a user not associated with the users based at least in part on the data. For example, a user of another electronic device receives a recommendation to listen to a pop song.

In an example embodiment, the processor 502 of the server 505 may be configured to send an advertisement to at least one of the users. For example, the processor 502 sends an offer to purchase pop music to a user.

In an alternative embodiment, the processor 502 of the server 505 may be configured to send an advertisement to a user not associated with the users. For example, the processor 502 sends an offer to purchase pop music to a user not associated with the users.

In an example embodiment, the processor 510 of the electronic device 548 is configured to receive an advertisement for at least one of the users. For example, a user of the electronic device 548 receives an advertisement to purchase pop music. In an alternative embodiment, the processor 510 of the electronic device 548 is configured to receive an advertisement to a user not associated with the users.

In an embodiment, the advertisement may comprise a cost savings. For example, the advertisement is a coupon, a service fee savings, and/or the like for the user. In an alternative embodiment, another electronic device is configured to receive an advertisement. For example, a user of another electronic device receives an advertisement to purchase a pop music video.

In an example embodiment, the processor 502 of the server 505 is configured to send instructions to block use of media not associated with the data. For example, the processor 502 sends instructions to block country music in a geographic area associated with the data in the database 507.

In an example embodiment, the processor 510 of the electronic device 548 is configured to receive instructions to block the use of media not associated with the data. Further, the processor 510 is configured to block the use of media not associated with the data, e.g., not pop music. For example, the processor 510 blocks a user in the geographic area associated with the data of listening to country music. In an alternative embodiment, another electronic device is configured to block the user of media not associated with the data. For example, a user is blocked from playing country music.

In an example embodiment, the server 505 is configured to remove the data associated with each of the users. In an embodiment, the server 505 is configured to remove the data based on an expiration of time. For example, the server 505 removes the data in the database 507, which is more than two years old. In an alternative embodiment, the server 505 is configured to remove the data based on a frequency of use. For example, the server 505 removes the data in the database 507, which has not been updated in more than one year.

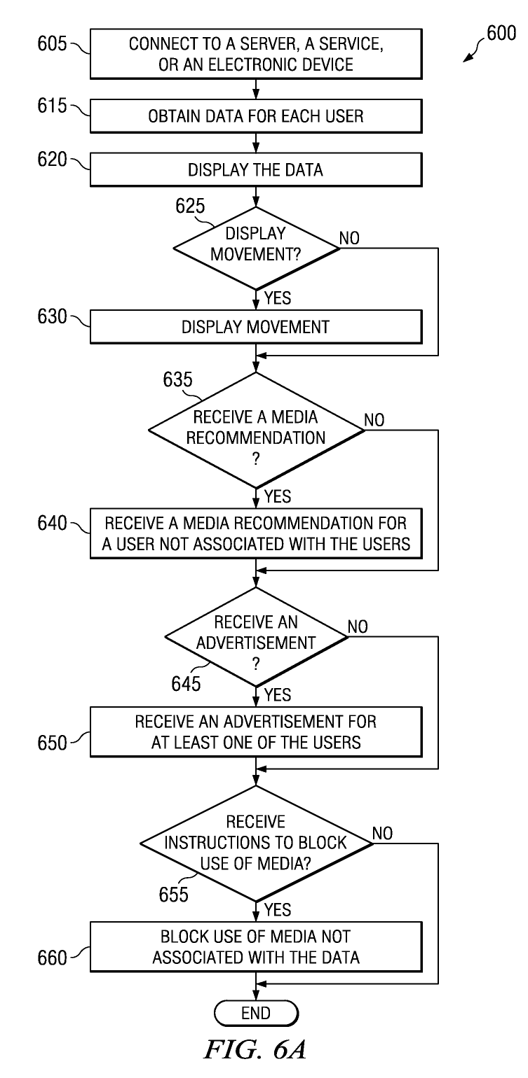

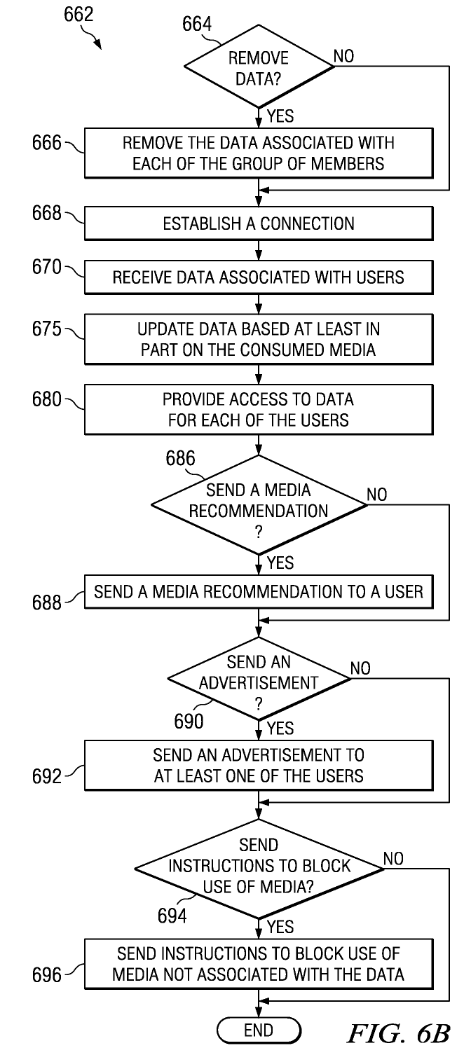

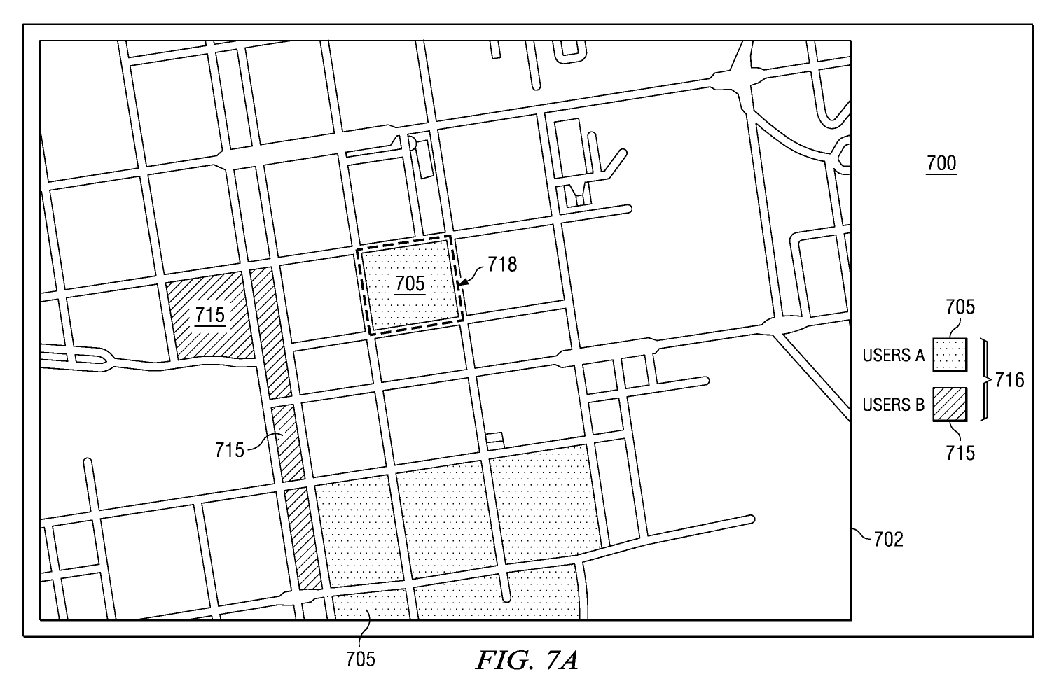

FIG. 6A is a flow diagram depicting an example method 600 for displaying data in accordance with an example embodiment of the invention. Example method 600 may be performed by an electronic device, such as electronic device 548 of FIG. 5.

At 605, an electronic device is connected to a server, such as server 505 of FIG. 5. In an example embodiment, a processor, such as processor 510, of the electronic device is configured to connect to a server, a service, another electronic device, and/or the like. For example, the electronic device establishes a connection over a network, such as Internet 514 of FIG. 5 with the server.

At 615, data for each of the users is obtained. In an example embodiment, the processor of electronic device is configured to obtain data for each of the users comprising in part the consumed data. For example, the processor obtains data relating to at least one user listening to a genre of music videos, e.g., pop music video from the server.

At 620, the data is displayed. In an example embodiment, a user interface, such as user interface 550 of FIG. 5, of the electronic device is configured to display the data. For example, the user interface displays music videos relating to genre preferences for the users. In an example embodiment, the user interface may display the data in at least one of the following views: a movement view, an ownership view, an icon view, or a text view.

At 625, it is determined whether movement is to be displayed. In an example embodiment, the processor of the electronic device determines whether movement data is received from the server. For example, the processor receives geographic coordinates from the server. If at 625 it is determined that movement is to be displayed, then at 630 the movement is displayed. In an example embodiment, user interface of the electronic device displays movement for at least one of the users. For example, the user interface displays a running path and/or associate speed for a user of the electronic device. The example method 600 continues at 635. If at 625 it is determined that no movement is to be displayed, the example method 600 continues at 635.

At 635, it is determined whether a media recommendation is to be received. In an example embodiment, the processor of the electronic device determines whether the media recommendation is received from the server. If at 635, it is determined that a media recommendation is to be received, then at 640 a media recommendation is received. In an example embodiment, the processor of the electronic device is configured to receive a media recommendation for a user not associated with the users based at least in part on the data. For example, a user of the electronic device receives a recommendation to view to a pop video. In an alternative embodiment, another electronic device is configured to receive a media recommendation to a user not associated with the users based at least in part on the data. For example, a user of another electronic device receives a recommendation to listen to a pop song. The example method 600 continues at 645. If at 635 it is determined that no media recommendation is to be received, the example method 600 continues at 645.

At 645, it is determined whether an advertisement is to be received. In an example embodiment, the processor of the electronic device determines whether the advertisement is received from the server. If at 645 it is determined that an advertisement is to be received, then at 650 the advertisement is received. In an example embodiment, the processor of the electronic device is configured to receive an advertisement for at least one of the users. For example, a user of the electronic device receives an advertisement to purchase a music video. In an alternative embodiment, another electronic device is configured to receive an advertisement. For example, a user of another electronic device receives an advertisement to purchase a pop music video. The example method 600 continues at 655. If at 645 it is determined that no advertisement is to be received, the example method 600 continues at 655.

At 655, it is determined if instructions to block use of the media are received. In an example embodiment, the processor of the electronic device determines instructions to block use of the media are received from the server. If at 655 it is determined that the instructions to block use of the media are received, then at 660, the use of media not associated with the data is blocked. In an example embodiment, the processor of the electronic device is configured to receive instructions to block the use of media not associated with the data. Further, the processor is configured to block the use of media not associated with the data. For example, the processor blocks the user of country music to the electronic device. In an alternative embodiment, another electronic device is configured to block the user of media not associated with the data. For example, a user is blocked from playing country music. The example method 600 ends. If at 655 it is determined that no instructions to block use of the media have been received, the example method 600 ends.

FIG. 6B is a flow diagram depicting an example method 662 for providing access to data in accordance with an example embodiment of the invention. Example method 662 may be performed by a server, such as server 505 of FIG. 5.

At 664 it is determined whether data is to be removed. In an embodiment, the server is configured to remove the data based on an expiration of time. For example, the server removes the data in a database, such as database 507 of FIG. 5, which is more than two years old. In an alternative embodiment, the server is configured to remove the data based on a frequency of use. For example, the server removes the data in the database, which has not been updated in more than one year.

If at 664 it is determined that the data is to be removed, then at 666 the data associated with each of the users is removed. In an example embodiment, the server is configured to remove the data associated with each of the users. The example method 662 continues at 668. If at 664 it is determined that the data is not to be removed, the example method 662 continues at 668.

At 668, the connection is established. In an example embodiment, the server is configured to establish a connection with an electronic device, such as electronic device 548 of FIG. 5. For example, the server establishes a connection over a network, such as the internet 514 of FIG. 5, with the electronic device.

At 670, the data associated with users is received. In an example embodiment, a processor, such as processor 502 of FIG. 5, of the server is configured to receive data comprising in part consumed media of the users. For example, the processor receives a media, such as a music video, in which the user was watching.

At 675, the data is updated based at least in part on the consumed media, e.g., data received at 670. In an example embodiment, the processor of the server is configured to update the data based at least in part on the data. For example, the data may be updated with the received data of 670 using a structured query language of the database 507.

At 680, access to the data for each of the users is provided. In an example embodiment, the processor of the server is configured to provide access to data for each of the users. For example, the processor allows access to the data via the database.

At 686 it is determined whether a media recommendation is to be sent. In an example embodiment, the server determines whether any recommendations relating to the data are available to send.

If at 686 it is determined that a media recommendation is to be sent, then at 688 a media recommendation is sent to a user. In an example embodiment, the processor of the server may be configured to send a media recommendation to a user not associated with the users based at least in part on the data. For example, the processor sends a pop music recommendation from the database to a user in the geographic location associated with the users. The example method 662 continues at 690. If at 686 it is determined that a media recommendation is not to be sent, then the example method 662 continues at 690.

At 690 it is determined whether an advertisement is to be sent. In an example embodiment, the server determines whether any advertisements relating to the data are available to send. If at 690 it is determined that an advertisement is to be sent, then at 682 an advertisement is sent. In an example embodiment, the processor of the server may be configured to send an advertisement to at least one of the users. For example, the processor 502 sends an offer to purchase pop music. The example method 662 continues at 694. If at 690 it is determined that an advertisement is not to be sent, then the example method 662 continues at 694.

At 694, it is determined if instructions to block use of the media are to be sent. In an example embodiment, the server determines if a user has configured a block to media not associated to the data. If at 694 it is determined that the instructions to block use of the media are to be sent, then at 696, the instructions to block use of the media not associated with the data are sent. In an example embodiment, the processor of the server is configured to send instructions to block use of media not associated with the data. For example, the processor sends instructions to block country music in a geographic area associated with the data in the database. The example method 662 ends. If at 694 it is determined that the instructions to block use of the media are not to be sent, then the example method 662 ends.

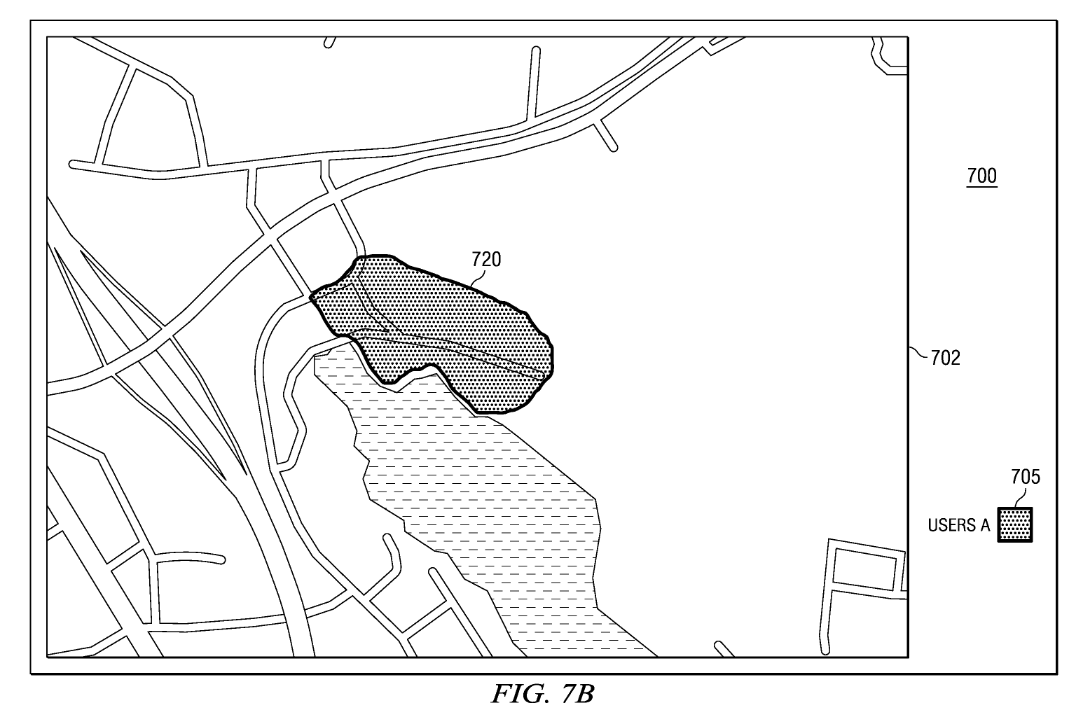

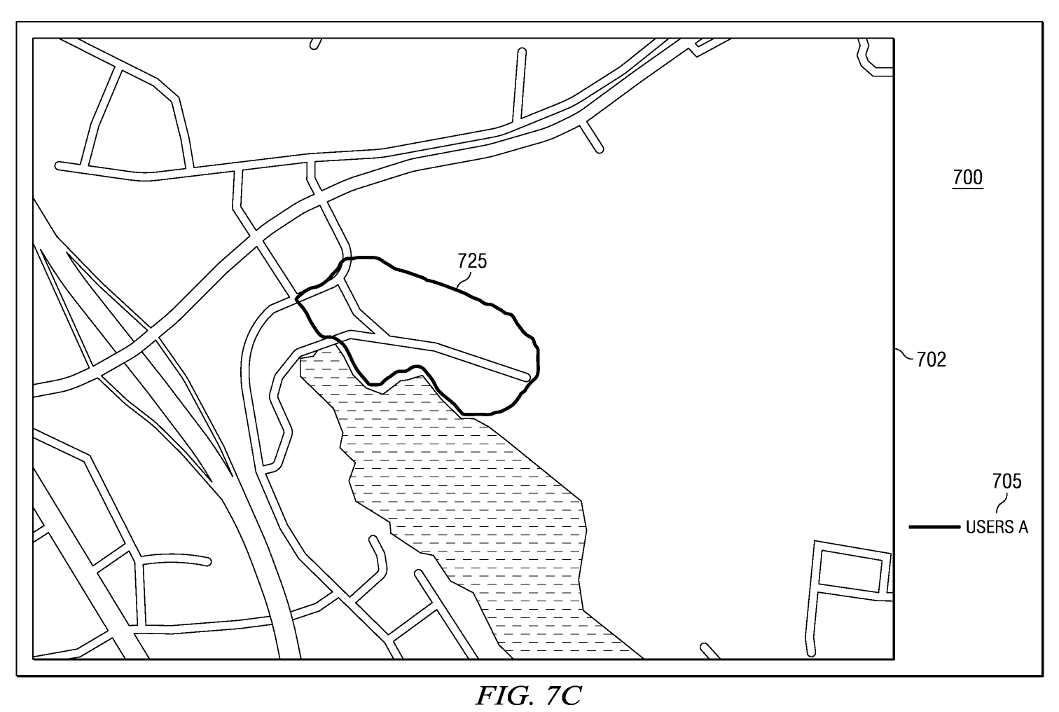

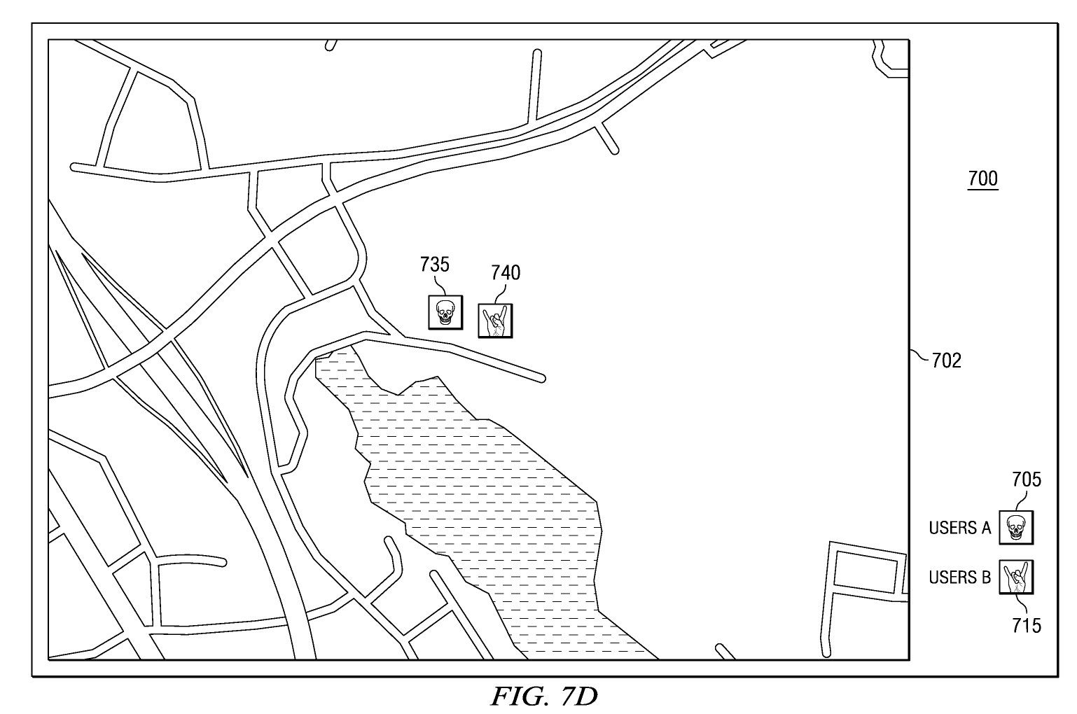

FIG. 7A is a screen view depicting a user interface 700 sharing an ownership view in accordance with an example embodiment of the invention. In an example embodiment, an electronic device, such as electronic device 548 of FIG. 5, comprises a user interface 700.

In an example embodiment, the user interface 700 displays data associated with users, such as users A 705 and/or users B 715. In an embodiment, the user interface 700 displays the data for each of the users on a map 702. In such a case, the data on the map 702 may be updated based at least in part on an action of each of the users. For example, users A 705 listen to blues music in a geographic region 718. In this example, the user interface 702 updates the map 702 associated with a representation as shown in key 716, which is related to users A 705, e.g., indicating ownership for users A 705 of the geographic region 718. It should be understood that the geographic region 718 may be subdivided into one or more geographic regions.

In an example embodiment, users B 715 are located in the geographic region 718. In such a case, users B 715 may listen to country music. In an embodiment, if users B 715 listens to more country music than users A 705 listens to blues music, then the user interface 702 updates the representation of the geographic region 718 to reflect an ownership change from users A 705 to users B 715.

In an example embodiment, the ownership of geographic region 718 for users B 715 may be transferred if users A 705 performs more actions, e.g., listening to blues music, than users B 715. In an embodiment, users B 715 weaken the ownership by lack of use. For example, if users B 715 do not walk the geographic region 718 using media, then the number of actions users A 705 is to perform to overtake ownership is decreased.

FIG. 7B is a screen view depicting a user interface 700 sharing another ownership view in accordance with an example embodiment of the invention. In an example embodiment, the user interface 700 displays data associated with users, such as users A 705 and users B 715, on a map 702. In an embodiment, the user interface 700 displays the data for each of the users on the map 702. In an example embodiment, users A 705 obtain ownership of a geographic region 720. In such a case, the data on the map 702 may be updated by adding color the geographic region 720.

Consider the following example. Users A 705 watch pop rock videos in the geographic region 720. Users A 705 watch more pop rock videos than any other users in the geographic region 720. In such a case, users A 705 are an owner of the geographic region 720. The user interface 700 colors the geographic region 720 to represent ownership of users A 705.

FIG. 7C is a screen view depicting a user interface 700 sharing a movement view movement view in accordance with an example embodiment of the invention. In an example embodiment, the user interface 700 displays data associated with users, such as users A 705, on a map 702. In an embodiment, the user interface 700 displays the data for each of the users on the map 702.

In an example embodiment, a processor, such as processor 510 of FIG. 5, of the electronic device determines whether movement data is received from a server, such as server 505 of FIG. 5. For example, the processor receives global positioning system data information from the server.

In an example embodiment, the user interface 700 is updated based at least in part on movement, e.g., the geographic location information associated with users, such as users A 705. In such a case, the data on the map 702 may be updated by creating a line or other representation on and/or around a geographic region 725. For example, the user interface 700 updates a walking path as a member of users A 705 move around the geographic region 725.

In an embodiment, the user interface 700 updates the geographic regions 725 for users A 705. For example, the users A 705 walk together in the geographic area 725. The user interface 700 displays a walking path. In an embodiment, the user interface 700 also displays the speed for one or more users. In such a case, it is possible to facilitate a race between users via the user interface 700. It should be understood that each member of users A 705 may view the updated display using an electronic device, such as electronic device 548 of FIG. 5.

FIG. 7D is a screen view depicting a user interface 700 sharing an icon view in accordance with an example embodiment of the invention. In an example embodiment, the user interface 700 displays an icon, such as icons 735, 740, associated with users, such as users A 705 and users B 715, on a map 702. In an example embodiment, users A 705 obtain ownership of a geographic region. The user interface 700 displays, for example, icon 735 associated with users to represent ownership. In an embodiment, the association to users A 705 relates to the consumed media of users A 705.

Consider the following example. Users A 705 listen to rap music in the geographic region. Users A 705 listen to more rap more than any other users in the geographic region. In such a case, the user interface 700 displays the icon 735 to represent the geographic region is owned by users A 705.

FIG. 7E is a screen view depicting a user interface 700 sharing a text view in accordance with an example embodiment of the invention. In an example embodiment, the user interface 700 displays text 755 on a geographic region 760 owned by a user. For example, users A, such as users A 705 of FIGS. 7A-D obtain ownership of the geographic region 760 and write text on the geographic region 760. In such a case, an electronic device, such as electronic device 548 of FIG. 5, is configured to receive text 755 from a user. In an embodiment, the user interface 700 displays the text 755 received from the electronic device on a map 702 within the geographic region 760. In an embodiment, the text 755 is visible to users displaying the geographic region 760.

Consider the following example. Users A 705 owns geographic region 760. Users A enjoys pop music and places text 755 stating, “Pop Rules” on the map 702. As a user not associated with users A 705 move into the geographic region 760, the user's map 702 displays the text 755 to the user.

Without in any way limiting the scope, interpretation, or application of the claims appearing below, it is possible that a technical effect of one or more of the example embodiments disclosed herein may be displaying an information list associated with a group. Another possible technical effect of one or more of the example embodiments disclosed herein may be storing an information list associated with a group. Another possible technical effect of one or more of the example embodiments disclosed herein may be updating the data based at least in part on the consumed media. Another possible technical effect of one or more of the example embodiments may be displaying a representation of ownership for the users in a geographic area.

Embodiments of the present invention may be implemented in software, hardware, application logic or a combination of software, hardware and application logic. The software, application logic and/or hardware may reside on an electronic device or a server. If desired, part of the software, application logic and/or hardware may reside on an electronic device and part of the software, application logic and/or hardware may reside on a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
obtaining data based at least in part on an action of users related to consumed media; and
displaying an indicator associated with the data.

2. The method of claim 1 wherein the action relates using media, changing a geographic location, making a phone call, watching an advertisement, using an application, sending a message.

3. The method of claim 2 wherein the consumed media is at least one of the following: audio, video, text files, a podcast, an image sharing application, a really simple syndication reader, rich summary site reader, or resource description framework summary site reader.

4. The method of claim 1 wherein the data is displayed on a map.

5. The method of claim 1 wherein displaying the data further comprises displaying the data in at least one of the following views: a movement view, an ownership view, an icon view, or a text view.

6. The method of claim 1 wherein displaying the data further comprises displaying an indicator.

7. The method of claim 1 further comprising receiving a media recommendation to at least one of the users not associated with the consumed media.

8. The method of claim 1 further comprising receiving an advertisement for at least one of the users.

9. The method of claim 1 further comprising connecting to a server, a service, or an electronic device.

10. An apparatus, comprising:
a processor configured to:
obtain data based at least in part on an action of users related to consumed media; and
a user interface configured to:
display an indicator associated with the data.

11. The apparatus of claim 10 wherein the action relates using media, changing a geographic location, making a phone call, watching an advertisement, using an application, sending a message.

12. The apparatus of claim 11 wherein the consumed media is at least one of the following: audio, video, text files, a podcast, an image sharing application, a really simple syndication reader, rich summary site reader, or resource description framework summary site reader.

13. The apparatus of claim 10 wherein the user interface is further configured to display the data on a map.

14. The apparatus of claim 10 wherein the user interface is further configured to display the data in at least one of the following views: a movement view, an ownership view, an icon view, or a text view.

15. The apparatus of claim 10 wherein the user interface is further configured to display an indicator.

16. The apparatus of claim 10 wherein the processor is further configured to receive a media recommendation to at least one of the users not associated with the consumed media.

17. The apparatus of claim 10 wherein the processor is further configured to receive an advertisement to at least one of the users.

18. The apparatus of claim 10 wherein the processor is further configured to connect to a server, a service, or an electronic device.

19. The apparatus of claim 1O, wherein the processor comprises at least one memory that contains executable instructions that if executed by the processor cause the apparatus to: transmit data based at least in part on an action of users related to consumed media.

20. A computer-readable medium encoded with instructions that, when executed by a computer, perform:
obtaining data based at least in part on an action of users related to consumed media; and
displaying an indicator associated with the data.

21-46. (canceled)
